(19) United States
(12) Patent Application Publication
(10) Pub. No.: US 2019/0228085 A1
(43) Pub. Date: Jul. 25, 2019

(54) LOG FILE PATTERN IDENTIFIER

(71) Applicant: CA, Inc., New York, NY (US)

(72) Inventors: Sayan Biswas, Kolkata (IN); Shashanka Arnady, Bangalore (IN); Nithin BG Shakthidhar, Tumkur (IN)

(21) Appl. No.: 15/875,089

(22) Filed: Jan. 19, 2018

(51) Int. Cl. G06F 17/30; G06F 11/34; G06F 17/10

(52) U.S. Cl. CPC G06F 17/30144; G06F 17/30109; G06F 17/10; G06F 11/3476

(57) ABSTRACT

An intelligent log file pattern identifier (“pattern identifier”) has been created that intelligently mines log files for patterns in a reduced time complexity of O(N²), which is substantially faster than O(N³). This pattern identifier can leverage truncated hashes of events, a suffix array, and a longest common prefix array to reduce the time complexity of pattern mining from O(N³) to a worst-case time complexity of O(N²). The pattern identifier analyzes event records in a log file using a multi-stage process to perform pattern mining. The multi-stage process involves filtering event records to preserve their static content, performing suffix sorting, and determining common prefix lengths of the suffixes of the static content to determine a full set of non-overlapping patterns across the event records. The pattern identifier then determines and generates a set of unique transaction patterns based on the non-overlapping patterns.

### BACKGROUND

The disclosure generally relates to the field of data processing, and more particularly to artificial intelligence.

Modern applications generate various event records that occur during a system transaction. These event records are stored in one or more log files from one or more data sources. These log files can be analyzed to keep track of system activity during normal and abnormal operations in computer systems. Each event record in a log file includes text-based information regarding the event (e.g., an event initiator, an event time, and an event action). The information stored in the log files is useful for various activities such as correlating events to transactions, identifying anomalies, performing root cause analysis, etc.

### BRIEF DESCRIPTION OF THE DRAWINGS

Embodiments of the disclosure may be better understood by referencing the accompanying drawings.

FIG. 1 is a diagram of an intelligent pattern identifier that identifies and stores transaction patterns based on a log file.

FIGS. 2 and 3 are flowcharts of example operations for efficiently and intelligently identifying patterns within a log file.

FIG. 4 depicts an example computer system with an intelligent O(n²) pattern identifier.

### DESCRIPTION

The description that follows includes example systems, methods, techniques, and program flows that embody embodiments of the disclosure. However, it is understood that this disclosure may be practiced without these specific details. For instance, this disclosure refers to patterns across lines of event records in illustrative examples. Embodiments of this disclosure can be applied to logs that use a delimiter other than a newline. In other instances, well-known instruction instances, protocols, structures and techniques have not been shown in detail in order not to obfuscate the description.

Overview

Information regarding transactions can be very useful for a variety of diagnostic and predictive purposes. Examples of this transaction information include transaction frequency and correlation with system events. The transaction information is communicated to an application(s) as events or event records that the application(s) records into a log file. Many transactions do not have a 1:1 correspondence with a single event record, but are instead characterized by a pattern distributed across multiple event records. Usually a newline is a delimiter between event records, resulting in the log file having multiple lines for each transaction. The recurring set of events across lines that represents a transaction creates a pattern (“multiline pattern”). Various methods can be used for mining one or more log files to determine the existence of a multiline pattern (“pattern mining”) and then detect the occurrences of the multiline patterns in a log file. However, pattern identifiers that perform pattern mining across N event records have previously had a time complexity of O(N³), which can be prohibitively costly when N is large (e.g., millions of events). Modern applications store ever-increasing numbers of event records in log files, which quickly increases the value of N.

In addition, pattern mining at the expense of O(N³) complexity can result in low quality results when the log being mined has events from heterogeneous data sources. Not only are the number of events generated out of applications increasing, but the complexity of applications (e.g., enterprise applications) is increasing. Heterogeneous data sources that are a part of a distributed application or are used by a distributed application often generate events with different semantic, formatting, and/or vocabulary. In such cases, a non-intelligent pattern identifier would fail to recognize patterns across events.

An intelligent log file pattern identifier (“pattern identifier”) has been created that intelligently mines log files for patterns in a reduced time complexity of O(N²), which is substantially faster than O(N³). This pattern identifier can leverage truncated hashes of events, a suffix array, and a longest common prefix array to reduce the time complexity of pattern mining from O(N³) to a worst-case time complexity of O(N²). The pattern identifier analyzes event records in a log file using a multi-stage process to perform pattern mining. The multi-stage process involves filtering event records to preserve their static content, performing suffix sorting, and determining common prefix lengths of the suffixes to determine a full set of non-overlapping patterns across the event records. The pattern identifier then determines and generates a set of unique transaction patterns based on the non-overlapping patterns.

Before determining patterns from the log file, the pattern identifier pre-processes the log file to sanitize or normalize the log file. The pattern identifier normalizes and tokenizes each event record of the log file to identify non-conforming tokens based on a dictionary. The normalizing can include stemming, lemmatization, removal/replacement of undefined tokens, etc. In addition to increasing the efficiency of later operations, this normalization removes linguistic variations across event records from different event sources (e.g., different monitoring agents or tools). The pattern identifier can deem tokens not found in the dictionary to be variable (e.g., usernames) and replace them with a token that represents variables (e.g., replaces a username with “$var”) to generate the normalized version of the log file.

After pre-processing, the pattern identifier replaces each event record with a hash value that represents the event record. The pattern identifier can then further compact the hash value representation by truncating it. Thus, the pattern identifier has substantially compacted the event records to allow for more efficient processing.

The pattern identifier generates a sorted suffix array (suffix array) from the compacted representation of the events records and a corresponding array of the lengths of the longest common prefixes (LCPs) for the suffix array. The pattern identifier then uses the suffix array and the LCP array to determine non-overlapping suffixes. The non-overlapping suffixes are correlated with a mapping of the compacted representations of the event records back to the entries in the log file to determine unique patterns within the log file. Once generated, the determined, unique patterns can be used for various diagnostic and predictive activities (e.g., root cause analysis, anomaly detection, optimization, etc.) across different types of applications.

Example Illustrations

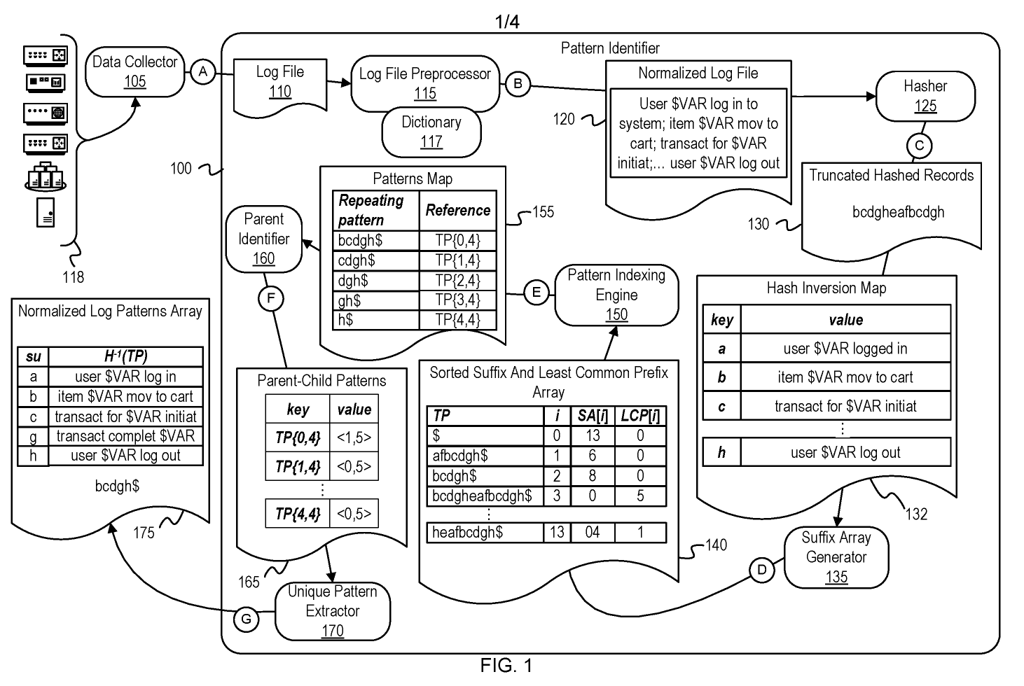

FIG. 1 is a diagram of an intelligent pattern identifier that identifies and stores transaction patterns based on a log file. FIG. 1 depicts a pattern identifier 100 which includes a log file preprocessor 115, a hasher 125, a suffix array generator 135, a pattern indexing engine 150, a parent identifier 160, and a unique pattern extractor 170.

FIG. 1 is annotated with a series of letters A-G. These letters represent stages of one or more operations in each stage. Although these stages are ordered for this example, the stages illustrate one example to aid in understanding this disclosure and should not be used to limit the claims. Subject matter falling within the scope of the claims can vary with respect to the order and to some of the operations.

At stage A, the data collector 105 collects data from one or more devices 118 and generates a log file 110 for consumption by the log file preprocessor 115. The log file 110 includes event records from one or more sources, each of which includes information such as an event initiator, an event time, and an event action. For example, below is an example set of event records in the log file 110, wherein a first device of the devices 118 provides the first seven events and a different device of the devices 118 provides the subsequent five events:

user user1 has logged in to system at 13:01
item collar moved to cart
transaction for 1056Rs initiated
transaction completed at 13:05
user user1 logged out
system health-check scheduled at 13:10
run clean-up
clean-up completed
user user2 logged in to system at 13:15
item leash moved to cart
transaction for 10Rs initiated at 13:27
transaction completed at 13:28
user user2 logged out

At stage B, the log file preprocessor 115 processes the log file 110 to generate the standardized log file 120. The normalized log file 120 includes a collection of normalized event records, each of which have been processed to convert variants of words found in a dictionary 117 into a single form and to remove/replace tokens not found in the dictionary 117. The log file preprocessor 115 tokenizes event records based on one or more delimiters and then applies stemming to each tokenized event record to reduce words to their word stems (e.g., stem “generating” to the root token “generat”). The log file preprocessor 115 then replaces each token in the event records that are not found in the dictionary 117 with a token such as “$VAR” to increase token processing consistency. For example, the dictionary 117 includes the tokens {“item”, “mov”, “to”, “cart”}. Using the dictionary 117, the log file preprocessor 115 converts an event record that recites “item airplane mov to cart” into the normalized event record “item $VAR mov to cart.” The log file preprocessor 115 may process the time in an event record differently depending upon eventual use. As examples, the log file preprocessor 115 may replace time in an event record with a token specifically defined for time values, replace time in an event record with the same token for all variables, or remove the time information. Using the above example log file, the log file preprocessor 115 converts each line of the log file 110 to generate the normalized log file 120 shown below in Table 1:

TABLE 1
Normalized Log File

| Line | Normalized Log Line |
|---|---|
| 0 | user $VAR$ log in to system at $VAR$ |
| 1 | item $VAR$ mov to cart |
| 2 | transact for$VAR$ initiat |
| 3 | transact complet at $VAR$ |
| 4 | user $VAR$ log out |
| 5 | system health-check schedul at $VAR$ |
| 6 | run clean-up |
| 7 | clean-up complet |
| 8 | user $VAR$ log in to system at $VAR$ |
| 9 | item $VAR$ mov to cart |
| 10 | transact for Rs. $VAR$ initiat at $VAR$ |
| 11 | transact complet at $VAR$ |
| 12 | user $VAR$ log out |

At stage C, the hasher 125 generates truncated hashed records 130 and a hash inversion map 132. The hasher 125 hashes each of the event records in the normalized log file 120 to generate a hashed record using a cryptographic hashing algorithm. The hasher 125 then truncates each hashed record and combines them into the truncated hashed records 130. The hasher 125 generates the hash inversion map 132 simultaneously with or after generating truncated hashed records 130. The hash inversion map 132 includes a set of key-value pairs, wherein each key is one of the truncated hashed event records and each value is the corresponding normalized event record. As will be described below for stage G, the pattern identifier 100 uses the hash inversion map 132 to determine transaction patterns based on a set of hashed patterns. For example, a hashing algorithm can be used to generate the data shown in Table 2 below, wherein each row includes a normalized event record, the corresponding hashed record (the full hash value is not indicated for ease of explanation), and the corresponding truncated hashed record.

TABLE 2
Correspondence of Representations of Event Records

| | | | truncated |
|---|---|---|---|
| | | hashed | hashed |
| Line | Normalized Event Record | record | record |
| 0 | user $VAR$ log in to system at $VAR$ | b113 . . . | b |
| 1 | item $VAR$ mov to cart | c451 . . . | c |
| 2 | transact for $VAR$ initiat | d625 . . . | d |
| 3 | transact complet at $VAR$ | g342 . . . | g |
| 4 | user $VAR$ log out | h254 . . . | h |
| 5 | system health-check schedul at $VAR$ | e542 . . . | e |
| 6 | run clean-up | a598 . . . | a |
| 7 | clean-up complet | f483 . . . | f |
| 8 | user $VAR$ log in to system at $VAR$ | b113 . . . | b |
| 9 | item $VAR$ mov to cart | c451 . . . | c |
| 10 | transact for $VAR$ initiat | d625 . . . | d |
| 11 | transact complet at $VAR$ | g321 . . . | g |
| 12 | user $VAR$ log out | h254 . . . | h |

As shown above in Table 2, the hasher 125 can use a hashing algorithm and truncate the hashed record to occupy less space than the hash value, which is a significant reduction down to one character in this example. The example illustration uses a single character truncation length for ease of illustration. Due to likelihood of collision, a hashed record will not be truncated down to that extent. The truncated hashed records 130 includes each individual truncated hash record, and can be represented by the string “bcdgheafbcdgh,” which is also identified as HASHLIST herein. Each entry of HASHLIST is one of the truncated hashed records. For the subsequent processing, HASHLIST is treated as a source or input string. When considered as a string, each truncated hashed record can be considered a “character” of the “alphabet,” which in this case is the universe of possible truncated hash values. Since HASHLIST is treated as a string of truncated event record hashes, the description sometimes refers to an entry in HASHLIST as a position.

In step D, the suffix array generator 135 generates a suffix array and a LCP array, which can be combined into a combined array 140 using the difference cover modulo 3 (DC3) algorithm. Implementations may generate multiple arrays with corresponding entries (e.g., a suffix array, suffix starting position array, and a LCP array all having correspondence among entries), but the illustration refers to a single combined array 140 for ease in explanation.

To generate the suffix array in the combined array 140, the suffix array generator 135 generates suffixes based on HASHLIST and then lexicographically sorts the suffixes. Table 3 below shows the suffixes from HASHLIST as sorted in lexicographically increasing order, where the character “$” represents an end-of-array character that is used for consistency in array operations. Table 3 also shows the suffix starting position for a suffix in the sorted array at an index i is represented as “SA[i]” and the length of the LCP for the suffix at SAN is represented as “LCP[i].” The suffix array generator 135 traverses the sorted list of suffixes and determines the LCP lengths across the suffixes as sorted:

TABLE 3
Mapping of Sorted Suffixes to Starting Positions and LCP lengths

| Suffix | i | SA [i] | LCP [i] |
|---|---|---|---|
| $ | 0 | 13 | 0 |
| afbcdgh$ | 1 | 6 | 0 |
| bcdgh$ | 2 | 8 | 0 |
| bcdgheafbcdgh$ | 3 | 0 | 5 |
| cdgh$ | 4 | 9 | 0 |
| cdgheafbcdgh$ | 5 | 1 | 4 |
| dgh$ | 6 | 10 | 0 |
| dgheafbcdgh$ | 7 | 2 | 3 |
| eafbcdgh$ | 8 | 5 | 0 |
| fbcdgh$ | 9 | 7 | 0 |
| gh$ | 10 | 11 | 0 |
| gheafbcdgh$ | 11 | 3 | 2 |
| h$ | 12 | 12 | 0 |
| heafbcdgh$ | 13 | 4 | 1 |

In step E, the pattern indexing engine 150 determines patterns of the truncated, hashed event records based upon a listing of patterns (AR) as represented by the ordered sets (TP) and distinguishes between those patterns that are overlapping and non-overlapping. TP represents a pattern of truncated, hashed records in relation to HASHLIST. As shown below in Equation 1, TP {i, j} is an ordered set of truncated, hashed records from entry i to entry j within HASHLIST:

TP{i,j}:={HASHLIST[x]|i≤x≤j} Equation 1

Thus, a pattern of truncated event record hashes in entry x of the listing AR can be expressed AR[x]=TP{i, j}. The pattern indexing engine 150 generates a patterns map 155. The patterns map 155 identifies patterns by referring to a pairing of the starting position of the pattern within HASHLIST and ending position of the pattern, which is expressed as TP(SA[i], SA[i]+(LCP[i]−1)). The ending position of the pattern is determined by adding the LCP length to the starting position and decrementing by 1 to account for the first entry of TP beginning at 0. The pattern indexing engine 150 uses the LCP lengths to identify patterns. The pattern indexing engine 150 traverses through the suffix and LCP array 140 to identify every non-zero entry of the LCP array. A LCP[i] entry is non-zero when its corresponding suffix shares a prefix with a preceding suffix as sorted. Because each suffix represents a portion of the truncated hashed log, the shared prefixes represent patterns within the normalized log file 120.

In some cases, patterns may be overlapping with each other within the source string, which in this example is HASHSTRING. Patterns are determined based on a pair of suffixes having a common prefix. This common prefix shared between a pair of suffixes may occur in overlapping segments of the source string. To illustrate an example overlapping pattern, a hashed array hashar1 “abbba” having a first suffix “bbba” at an index value i and a second suffix “bba” at an index value 1-1 will have a pattern “bb” corresponding with the index value i. The pattern “bb” occurs in the prefix of the suffix starting at hashar1[1] and the prefix in the suffix starting at hashar1[2]. Thus, the pattern “bb” is an overlapping pattern because both the i-th and (i−1)-th entries refer to the exact same segment of hashar1 for the pattern “bb.” For pattern mining, the pattern identifier 100 identifies the non-overlapping patterns that repeat. Thus, the pattern identifier 100 extracts the longest, non-overlapping pattern than can be extracted from overlapping, patterns. This avoids identifying misleading or redundant patterns. To do so, the pattern indexing engine 150 calculates the maximal non-overlapping segment lengths at each index i (L[i]) with a non-zero LCP[i]. The pattern indexing engine generates L[i] from the absolute value of the difference in starting positions between a suffix array entry and the preceding suffix array entry, which is expressed in Equation 2 below:

L[i]:=|SA[i−1]−SA[i]| Equation 2

If the maximal non-overlapping segment length is greater than or equal to the LCP length, then the LCP length doesn't include overlap. In the example HASHLIST “bcdgheafbcdgh,” each pattern of the set (i.e., “bcdgh,” “cdgh,” “dgh,” “gh,” and “h”) is a non-overlapping pattern because the patterns are not shared between their entry i and entry i−1. However, for other strings representing truncated hashed event records, overlapping patterns can exist.

For example, if the string “banana” represents the truncated hashed event records 130 instead of “bcdgheafbcdgh,” Table 4 can be generated as shown below, wherein SA[i], LCP[i], and L[i] are determined as described above:

TABLE 4
Combined Mapping With Maximal Non-Overlapping Segment Lengths

| Suffix | i | SA [i] | LCP [i] | L [i] |
|---|---|---|---|---|
| $ | 0 | 6 | 0 | 0 |
| a$ | 1 | 5 | 0 | 1 |
| ana$ | 2 | 3 | 1 | 2 |
| anana$ | 3 | 1 | 3 | 2 |
| banana$ | 4 | 0 | 0 | 1 |
| na$ | 5 | 4 | 0 | 4 |
| nana$ | 6 | 2 | 2 | 2 |

The pattern indexing engine 150 uses L[i] to determine whether a pattern is within overlapping segments of the string. When L[i] is greater than or equal to LCP[i], the common prefixes of a pair of suffixes does not occur in overlapping segments. For example, with reference to Table 4 above, at i=2, LCP[i]=1, the suffixes “ana$” and “a$” have a common prefix of “a.” The distance between starting positions of the two suffixes is 2 (SA[2]−SA[1]=L[2]). Since L[2] is 2, L[i] is greater than LCP[2], which means that the starting positions are far enough that the common prefix “a” in the suffixes is not within an overlapping segments of the suffixes.

If L[i] is less than LCP[i], the common prefix of the suffixes corresponding to entries i and i−1 in the suffix array occurs in segments of the suffixes that overlap within the string. When overlap is determined for a pattern, the pattern indexing engine 150 identifies and extracts the overlapping and non-overlapping portions of the overlapping pattern. For example, with reference to Table 4 above, at i=3, LCP[i] is equal to 3 because the prefixes “ana$” and “anana$” share three hashed values. Since L[i] is 2, L[i] is less than LCP[i] and the shared pattern “ana” overlaps between “ana$” and “anana$”. The common prefix of the suffixes overlap at the “a” occurring at SA[3]. The pattern indexing engine 150 accounts for both the non-overlapping portion “an” as well as the overlapping portion “a” by first generating a temporary array AR^{T} having a length of (LCP[i]−L[i]+1). For example, with continued reference to Table 4 above, at the row i=3, the length of AR^{T} is equal to 2, and each of the entries in the temporary array AR^{T} can be determined based on Equation 3, where k can be any value variable in the range from zero to (LCP[i]−L[i]):

AR^{T}[k]:=TP{(SA[i]+k),SA[i]+k+L[i]−1} for all k∈[0, . . . ,LCP[i]−L[i]])

With reference to Table 4, at the row i=3, SA[i=3] is 1, L[i=3] is 2, and LCP[i=3] is 3. Using Equation 3 for both the k=0 and k=1 case, AR^{T}[0] is TP{1+0, 1+0+1}=TP{1, 2} and AR^{T}[1] is TP{1+1,1+1+1}=TP{2,3}. The concatenation of TP{1,2} and TP{2,3} is determined to be the pattern extracted from the overlapping suffixes. If the example patterns from the truncated hashed records 130 had overlapping, then each of the entries in the array AR^{T} would be accumulated and added to the pattern maps 155.

At step F, the parent identifier 160 generates the parent-child patterns structure 165 based on the pattern maps 155. In this illustration, the parent-child patterns structure 165 is a key-value store. The patterns mapped by the pattern maps 155 can contain redundant patterns that are already part of a larger pattern. For example, based on the same suffix array shown above in Table 3, the pattern maps 155 are represented by the data shown in Table 5 below, which includes both a mapping that maps to the longer pattern “bcdgh” and four shorter patterns.

TABLE 5
Pattern Maps

| Pattern Maps | Patterns | SA [i] | SA [i] + LCP [i] − 1 |
|---|---|---|---|
| TP{2,4} | dgh | 2 | 4 |
| TP{0,4} | bcdgh | 0 | 4 |
| TP{1,4} | cdgh | 1 | 4 |
| TP{4,4} | h | 4 | 4 |
| TP{3,4} | gh | 3 | 4 |

The parent identifier 160 pattern sets the keys in the parent-child patterns structure 165 to be the reference values from the patterns maps 155, each of which is location information of the patterns. The parent identifier 160 sets the value corresponding to the keys to be a two-component tuple that includes a two-state indicator (e.g., a boolean) and a parent-pattern length. The two-state indicator indicates whether the corresponding pattern is a “parent pattern” or a “child pattern.” A “parent pattern” is a pattern that does not occur within another pattern of the source string. A “child pattern” is a pattern that occurs within another pattern of the source string. While iterating through the pattern maps 155, the parent identifier 160 changes the parent-child indicator from parent to child when a previously encountered pattern from the patterns map 155 occurs within a later encountered pattern from the patterns map 155.

The parent identifier 160 identifies each unencountered pattern as a parent pattern. In response to identifying a parent pattern, the parent identifier 160 adds a new key-value pair to the parent-child patterns structure 165, wherein the unencountered pattern reference is the key and a two-component tuple is the corresponding value. The first component of the two-component tuple is an indicator that indicates that the unencountered pattern is a parent pattern (e.g., “1” for parent patterns, “0” otherwise). The second component of the two-component tuple is a value representing the length of the unencountered parent pattern. For example, with reference to Table 5, if the parent identifier 160 processes the pattern “bcdgh” and “bcdgh” is not yet in the parent-child patterns structure 165, the parent identifier 160 adds the key-value pair “(TP{0,4}, <1, 5>),” which indicates that the pattern mapped by TP{0,4} (i.e., “bcdgh”) is a parent pattern with a length of five.

In addition, the parent identifier 160 will search the existing entries in the parent-child patterns structure 165 for each suffix of the newly inserted parent pattern. For each suffix of the newly inserted parent pattern, the parent identifier searches the parent-child patterns structure 165 to determine whether a matching entry already exists within the structure 165. Assuming 0 indicates child and 1 indicates parent, then based on the notation of P1 <1,x> representing the newly inserted parent pattern P1 with a length of x; P2 <|0,1|,y> representing an existing entry for pattern P2 with a parent pattern length of y; and Sₙ representing a suffix n of the n suffixes of P1, then the following are the update cases:

1) if P1==P2 and x<=y, then discard P1;
2) if P1==P2 and x>y, then update the entry for P2 to indicate P2 as a child and to indicate x as the length;
3a) if Sₙ==P2 and P2 is currently indicated as a parent, then update the entry for P2 to indicate P2 as a child and to indicate x as the length of the parent pattern for P2;
3b) if Sₙ==P2, P2 is currently indicated as a child, and x<=y, then discard Sₙ;
3c) if Sₙ==P2, P2 is currently indicated as a child, and x>y, then update the entry for P2 to indicate x as the length of the parent pattern for P2;
4) if Sₙ not found, then add entry for Sₙ<0, x> to the parent-child patterns structure 165.
For example, with reference to Table 5, after determining that “bcdgh” is a parent pattern, the parent identifier 160 will search the structure 165 for the suffixes “cdgh,” “dgh,” “gh,” and “h”. Since “cdgh” is not already in the parent-child patterns structure 165, the parent identifier 160 will add the key-value pair “(TP{1,4}, <0, 5>)” to the parent-child patterns structure 165. When the parent identifier 160 first encounters the pattern “cdgh” from the patterns map 155, the parent identifier 160 will find a matching entry in the parent-child pattern structure 165 that was previously inserted as a child based on the suffixes of “bcdgh.” The parent identifier 160 can then discard “cdgh” from consideration as a unique pattern.

At stage G, the unique pattern extractor 170 uses the hash inversion map 132 to determine the normalized log patterns array 175. The unique pattern extractor 170 can traverse the parent-child patterns structure 165 to collect the patterns indicated to be parent patterns. Each of the parent patterns is a unique pattern within the log (or hashed log). The unique pattern extractor 170 uses the hash inversion map 132 to map the unique patterns of truncated hashes back to their corresponding normalized event record. For example, the parent pattern “bcd” can be converted to the normalized log pattern comprising the event records “user $VAR log in,” “item $VAR mov to cart,” and “transact for $VAR initiat.”

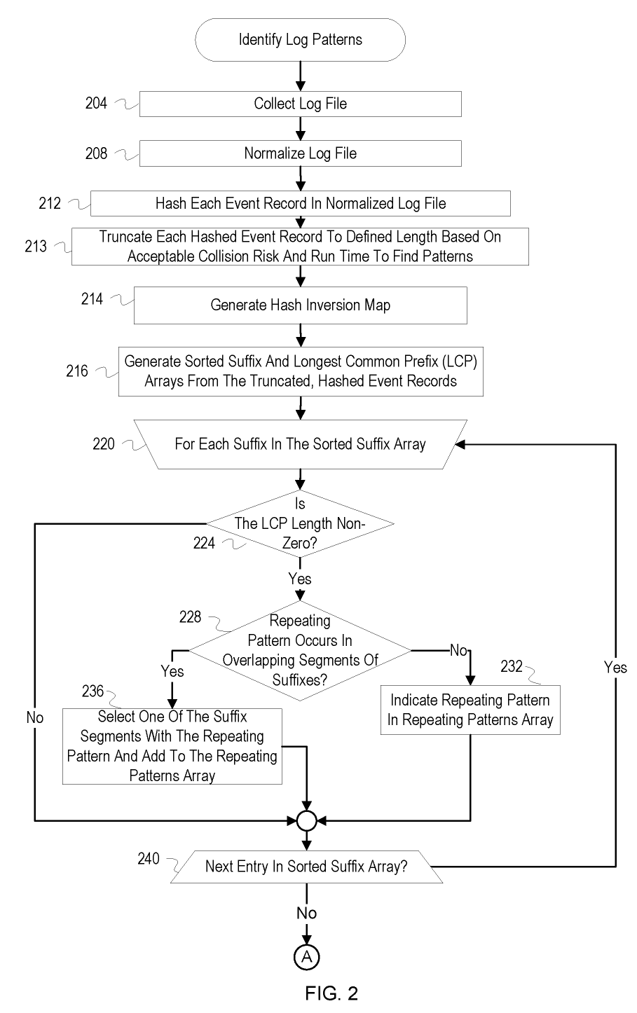

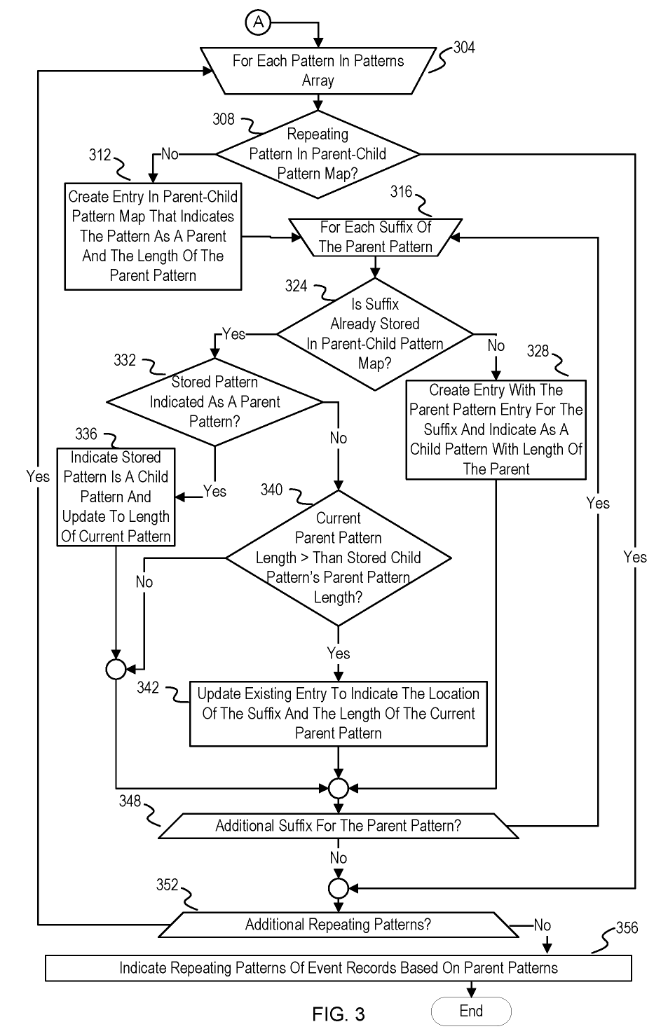

FIGS. 2 and 3 are flowcharts of example operations for efficiently and intelligently identifying patterns within a log file. The text-based event records in a log file can be used to identify patterns of events in the log file. The patterns can be used to scan and quantify complex system events, providing valuable information on the frequency, trends, and causes of system events. For instance, a pattern of events can correspond to a particular transaction in a distributed application. The flowcharts will refer to a pattern identifier as performing the operations for consistency with FIG. 1.

A pattern identifier collects a log file (204) which includes text-based event records from one or more devices. The pattern identifier can collect the log file by monitoring a database or be set to automatically receive a log file from an external data source. The pattern identifier can periodically mine a log file into which event records are written from various sources and/or be prompted to retrieve and mine the log file.

The pattern identifier normalizes the log file (208) to account for variations across different event record sources and identify variables. Normalization accounts for linguistic differences between different event record sources and increases the reliability of a token dictionary. Normalizing a log file can include stemming and lemmatization. The pattern identifier tokenizes the normalized event records. The pattern identifier may perform multiple passes over the log to allow for feedback between the normalizing and tokenization. The pattern identifier replaces variables within the event records with a token defined to represent variables (“variable token”). The pattern identifier may replace each token not found in the token dictionary with the variable token. The token dictionary or a separate set of heuristics can specify patterns that guide the pattern identifier to identify variables. For instance, the token dictionary or a set of heuristics can specify that the token immediately preceding the token “login” or following the token “user” is a variable to be replaced with the variable token. Embodiments can also use different classes of tokens to replace different types of variables (e.g., data variables, username variables, and other variables). As an example, a rule can specify that the first token in an event record that has a format of dddd-dd-dd (“d” representing any character that is a numeric character) be replaced with the token “$DATE.”

In order to reduce the storage requirements and decrease time complexity mining, the pattern identifier hashes and truncates the normalized event records. The pattern identifier generates a hash of each event record (212). The pattern identifier hashes each event record to increase the likelihood of a one-to-one correspondence between a hashed event record and similar event records (i.e., event records that share the same order of dictionary terms). In addition, hashing the event records can preserve distinctions between the hashed event records even after truncation. Moreover, because hashing is effectively an alphabetic conversion, hashing will not impact the generation of the suffix array or the LCP array described further below. The pattern identifier can use various hashing algorithms, such as a 160-bit secure hashing algorithm, 256-bit secure hashing algorithm, Keccak hashing algorithm, etc. For example, the pattern identifier can use the 256-bit secure hashing algorithm to convert the normalized event record “user $VAR log out” to a hexadecimal hashed event record that begins with the characters “B7ED3BCD62712267D . . . ” After generating the hashed event record, the pattern identifier can process the hashed record to convert the hashed record into other data types, such as a binary or numeric value.

The pattern identifier then truncates each hashed event record to a length based on a tradeoff between acceptable risk of collision and runtime to find a pattern (213). As described earlier, an aggregate of the N truncated event record hashes will be a source or input string into an algorithm(s) to find patterns within the input string. A number of values can be determined based on a chosen acceptable probability of collision among the N truncated event record hashes (e.g., with a formula based on the generalized birthday problem). And a length for each truncated event record hash determined that can represent the determined number of values and that results in an acceptable impact on runtime for the pattern finding algorithm (e.g., DC3 algorithm). The pattern identifier truncates the hash values to a length D. The length D represents a truncate length computed based on an acceptable risk of collision among N hash values (in this case N truncated event record hashes) with an acceptable pattern finding runtime at a length D for each truncated event record hash. While the time order complexity of the DC3 algorithm is expressed as O(n) based on input string length of n, the number of records N does not directly map to n since each “character” of the input string (i.e., the aggregated truncated event record hashes) is of length D. To select a truncation length with an acceptable tradeoff between impact on runtime and probability of collision, the length can be computed based on choosing a collision control parameter E for the Equation 4, wherein Σ≥1:

D=(└log₁₀ N┘+1)*∈ Equation 4

For example, in the case where N is equal to 10⁹, and ∈ is equal to 1.5, D is equal to 15 using Equation 4. D=15 results in the pattern identifier truncating the hashes to 15.

The pattern identifier generates a hash inversion map that maps the truncated and hashed event records back to the normalized event records (214). The hash inversion map can comprises key-value pairs, wherein each key is a truncated, hashed event record and each value indicates a normalized event record. For example, the indication of the normalized event record can be the normalized event record or a reference (e.g., line number) to the normalized event record.

The pattern identifier then generates a suffix array and a LCP array from the truncated, hashed event records (216). The pattern identifier treats the truncated, hashed event records as a string input into the algorithms for generating the suffix array and the LCP array. Embodiments can generate individual arrays, a multi-dimensional array, or another structure that preserves correspondence across the sorted suffix information and longest common prefix lengths. A suffix array can explicitly indicate the sorted suffixes in order with correspondence to their starting positions within the input string or can implicitly indicate the suffixes by ordering starting positions. For example, the suffix array represented as SA can indicate that the fourth character of the input string is the second suffix when sorted by setting the value for SA[1] to be 4.

After generating this set of arrays, the pattern identifier iterates over the arrays to determine non-overlapping, patterns within the truncated, hashed records (220). For each entry in the suffix array, the pattern identifier determines whether the corresponding entry in the LCP array is non-zero (224). If a suffix has a common prefix with another suffix, then that common prefix is a pattern within the input string. In some variations, instead of finding every non-zero entry in the LCP array, the pattern identifier can identify entries in the LCP array that are greater than a minimum threshold, and identify the patterns that correspond with these entries. In some embodiments, the log identifier can also count the occurrences of patterns while identifying the patterns. If the LCP length for the suffix is non-zero, then the pattern identifier moves on to the next entry in the suffix array (240). Otherwise, the pattern identifier determines whether the common prefix occurs in overlapping segments of the suffixes that share the common prefix (228).

The pattern identifier determines whether the common prefix occurs in overlapping segments to ensure distinct patterns will be identified (228). To determine whether the common prefix occurs in overlapping segments of the suffixes, the pattern identifier uses the difference between the LCP length and the distance between starting positions of the suffixes that share the common prefix. This difference is represented by L[ ] and referred to as the maximal non-overlapping segment length. The following can be used to demonstrate the validity of using L[ ] to determine if a pattern is an overlapping pattern and to extract the longest pattern from the overlapping pattern. Consider a string E comprising the characters “S₁S₂ . . . SᵢSᵢ₊₁ . . . SⱼSⱼ₊, . . . SₖSₖ₊₁ . . . $,” where each subscripted S represents a character. It should be apparent that i is less than j, and j is less than k. We can denote the suffix array of E as the array SA[ ].

The generic numbering of the subscripts of S allows the suffix starting with Sⱼ to be positioned at an index x (e.g., SA[x]=j) and the suffix starting with Sᵢ to be positioned at an index x+1 (i.e. SA[x+1]=i). The number of characters that are different between the suffix at x and x+1 are thus equal to the difference between i and j, which is equal to L[x+1] as shown in Equation 2 above (i.e., SA[x+1]−SA[x]=i−j=SA[x+1]). Without loss of generality, the scenario in which the value of LCP[x+1] is equal to k−i, and this value is non-zero.

This scenario leads to the assertion that the longest common prefix of SA[x] and SA[x+1] is “SᵢSᵢ₊₁ . . . SⱼSⱼ₊₁ . . . Sₖ₋₁,” which can be re-written as “SⱼSⱼ₊₁ . . . SₖSₖ₊ⱼ₋ᵢ₋₁. SⱼSⱼ₊₁ . . . SₖSₖ₊ⱼ₋ᵢ₋₁.” Notably, the string segment “SⱼSⱼ₊₁ . . . SₖSₖ₊ⱼ₋ᵢ₋₁. SⱼSⱼ₊₁ . . . SₖSₖ₊ⱼ₋ᵢ₋₁” is contained in the suffix “SᵢSᵢ₊₁ . . . SⱼSⱼ₊₁ . . . Sₖ₋₁.” Thus, the string segment “Sⱼ . . . Sₖ₋₁” is the overlapping portion between the two string segments “SᵢSᵢ₊₁ . . . ” and “SⱼSⱼ₊₁ . . . ” To further illustrate this, consider the following sub-string of E, wherein the square brackets represents the pattern as represented in the suffix for index x+1 and the curly brackets represent the same pattern for represented in the suffix for the index x: “[Sᵢ . . . Sⱼ₋₁ . . . {Sⱼ . . . Sₖ₋₁] . . . Sₖ . . . Sₖ₊ⱼ₋ᵢ₋₁}.” In the preceding sub-string of E, the segment between the curly bracket and the square bracket shows the overlapping portion that begins at Sⱼ and ends at Sₖ₋₁. Moreover, based on the above, the length of the maximal non-overlapping substring L[x+1] is (k−i)−(k−j)=j−i=SA[x]−SA[x+1]. If the pattern is not longer than the maximal non-overlapping segment length, then the pattern does not occur in overlapping segments of the suffixes. Otherwise, the pattern occurs in overlapping segments of the suffixes.

If the pattern does not occur in overlapping suffix segments, then the pattern identifier indicates the entire pattern to a patterns array (232). An array is not necessary, but embodiments will use a data structure that tracks the patterns discovered by the pattern identifier. For those not in overlapping suffix segments, they can be indicated in this data structure with any one of the starting and ending positions within the input string or the starting position and length of the pattern. Embodiments can also indicate the pattern itself as well as location within the input string.

If the pattern occurs in overlapping suffix segments, then the pattern identifier selects one of the suffix segments with the pattern and indicates the selected suffix segment in the patterns array (236). The pattern identifier can select the suffix segment with the pattern from the overlapping suffix segments by accumulating portions of the pattern as constrained by the maximal non-overlapping segment length based on the starting positions of the overlapping suffixes. For instance, the pattern identifier can accumulate the portions in the temporary array as discussed in FIG. 1.

After indicating patterns in the patterns array, the pattern identifier proceeds to the next entry in the suffix array, if any (240). If the pattern identifier has completed traversal of the suffix array, then the pattern identifier proceeds with processing the patterns to determine those of the patterns that are not sub-patterns of other patterns as described in FIG. 3. These patterns that are not sub-patterns of the patterns are referred to as unique patterns among the patterns.

FIG. 3 continues from FIG. 2. FIG. 3 depicts example operations for determining unique ones of the patterns and translating this information back into the normalized record event. Once the patterns array is available, the pattern identifier processes each pattern in the patterns array (304) to determine whether the pattern is a sub-pattern of another pattern. A pattern that is a sub-pattern is referred to as a child pattern. A pattern that is not a sub-pattern of another pattern is referred to as a parent pattern. Until complete processing of the patterns array, the characterization of a pattern as a child or a parent may be transient until the pattern identifier has iterated over all of the patterns. For instance, the first pattern that the pattern identifier encounters will start as a parent pattern since no other pattern has been processed yet, but may change to a child pattern based on a later pattern containing that first pattern. The data structure used to track the relationship of these patterns as child or parent with respect to their locations within the input string is referred to as a parent-child pattern map. The description refers to the pattern that the pattern identifier is currently processing as the “current pattern.”

The pattern identifier determines whether the current pattern is already in a parent-child pattern map (308). The pattern identifier can structure the parent-child pattern map with keys or indices that indicate the patterns by location of the patterns within the input string. The pattern identifier can search or attempt to access the parent-child pattern map with the location information to determine whether it is already in the parent-child pattern map. As an example, the location information is a key of the parent-child pattern map, and accessing the parent-child map with the key will provide a value if the current pattern is in the parent-child pattern map, or a null response otherwise. Alternatively, some embodiments can store the pattern in a value array in the parent-child pattern map, and the pattern identifier can search through the value array to determine whether the current pattern is present in the parent-child pattern map.

If the pattern is already in the parent-child pattern map, the pattern identifier will proceed to the next available pattern in the patterns array (352). If the pattern is already in the parent-child pattern map, then it would be a child pattern of another pattern.

If the pattern identifier determines that the parent-child pattern map does not already indicate the current pattern, then the pattern identifier creates an entry for the current pattern in the parent-child pattern map (312). The parent identifier creates the entry with an indication of the current pattern as a parent pattern and length of the current pattern. For example, the indicator can be a boolean value that is set to “true” if the pattern is a parent pattern and “false” if the pattern is not a parent pattern. The number indicating the length of the parent pattern can be an integer value. For example, the number can be a count of the total number of truncated hashed event records in the parent pattern.

The pattern identifier then iterates over each non-zero length suffix of the current pattern (316). The pattern identifier iterates of the suffixes of the current pattern to identify shorter patterns either already encountered from the patterns array or to be encountered from the patterns array. Eventually, the parent-child pattern map will be used to identify the longest patterns among the patterns that are not within others of the patterns.

The pattern identifier determines for each suffix of the current pattern whether the suffix is already stored in the parent-child pattern map (324). The pattern identifier compares the suffix against the patterns represented in the parent-child pattern map. The parent identifier reads the keys for the location information within the source string and compares the segment to the suffix. Some embodiments can store the suffixes and patterns as another value in the child-patterns map instead of reading the keys and then reading the source string. In some embodiment, the suffixes and patterns are used as the keys and the location information of the pattern within the input string is another value for the entry. If the suffix is not already in the parent-child pattern map, then the pattern identifier creates an entry for the suffix (328). The pattern identifier creates the entry for the suffix with location information of the suffix within the source string, an indication that the suffix is a child pattern, and with an indication of the length of the parent pattern of the suffix. After creating this child pattern entry for this suffix of the current pattern, the pattern identifier proceeds to the next suffix of the current pattern (348).

If a suffix of the current pattern is already within the parent-child pattern map (324), then the pattern identifier determines whether the pattern already stored in the parent-child pattern map is indicated as a parent pattern (332). If the already stored pattern matching the suffix is indicated as a parent pattern, then the pattern identifier changes the entry to indicate the pattern is a child pattern (336). This eliminates the pattern from being considered in later analysis since it occurs within another larger pattern. The pattern identifier also updates the length of the matching entry to be the length of the current pattern. After updating this entry to indicate the patter as a child, the pattern identifier proceeds to the next suffix of the current pattern (348).

If the pattern identifier determines that the stored pattern matching the suffix of the current pattern is not indicated as a parent pattern (332), then the pattern identifier determines whether the length of the current pattern is greater than the length of the parent pattern of the already stored child pattern that matches the suffix of the current pattern (340). If the already stored child pattern has a parent pattern with a greater length, then there is no use in adding the suffix as a child for the current pattern since the existing entry will eliminate matching patterns from being added to the map. If the pattern identifier determines that the parent pattern length of the already stored child pattern is larger, then the pattern identifier proceeds to the next suffix of the current pattern (348). Otherwise, the pattern identifier update the existing entry for the suffix (342). The parent identifier update the existing entry with the location information for the suffix as a child pattern of the current pattern and length of the current pattern (342). This effectively overwrites or removes the previously indicated child pattern, although the same pattern is still indicated in the parent-child patterns map. For that reason, embodiments can choose to indicate either of the child patterns since either one serves the purpose of preventing a newly encountered pattern from the patterns map from being indicated in the parent-child patterns map as a parent pattern. The pattern identifier then proceeds to the next suffix of the current pattern (348). If there are no additional suffixes for the current pattern (348), then the parent identifier determines whether there is an additional pattern in the patterns array to process (352). If there is an additional pattern, then the pattern identifier proceeds with processing the next pattern (304).

If the pattern identifier has finished traversing the patterns array, then the pattern identifier indicates patterns of normalized event records based on the parent patterns (356). The patterns indicated as parent patterns in the parent-child pattern map after the pattern identifier finishes processing the patterns are the longest patterns of the input string that are not contained within another pattern. Recall that the input string is the aggregation of truncated event record hashes. In terms of text processing, each truncated event record hash can be considered a character of the input string. The pattern identifier uses the previously created hash inversion map (214) to map the truncated event record hashes in the parent patterns back to normalized event records. The pattern identifier can generate the patterns of normalized event records for analysis. For instance, the pattern identifier can communicate the patterns of normalized event records to a root cause analysis tool or other analysis tool.

Typically, pattern mining a log involves candidate generation and candidate filtering in multiple passes over the log. This results in a time complexity of O(n³). To avoid confusing notation, n will now be used instead of N in explaining time order complexity of the disclosure in comparison to typical log pattern mining. The time complexity for identifying patterns in a log of n event records as described above achieves a time complexity of O(n²). The time complexity for finding patterns in an input string that does not have overlapping patterns would be O(n). But log pattern mining should identify non-overlapping patterns. The time complexity for determining overlapping patterns across n truncated hashed event records is approximated with a worst-case scenario wherein, for each of the n−1 suffixes, each of the LCP[i] entries are equal to the maximum possible value of n−i (e.g., LCP[i]=n−1. LCP[2]=n−2, etc.). Under these conditions, the maximum length of a non-overlapping pattern is equal to one, and thus the pattern determined at i=1 would have O(n) patterns to process for each of the n−1 suffixes. Thus, the operation to determine non-overlapping patterns is determined as O(n)*(n−1), which would yield a time complexity of O(n²).

Variations

The above example illustrations describe a pattern identifier that discovers patterns that are not within other patterns (referred to previously as unique patterns) of a compacted representation of a log. In some embodiments, the pattern identifier can be configured to use child patterns based on other criteria and convert the patterns to normalized log patterns. In some embodiments, the pattern identifier can use heuristics or models to recognize patterns beyond a threshold and replace them with a specified value that represents the corresponding transaction. For example, the pattern identifier can convert each pattern greater than 50 hexadecimal into a normalized log pattern.

As a second example, the pattern identifier can generate the suffixes of every pattern and keep track of how many times a pattern appears in the patterns array or is generated. For example, in a patterns array including the patterns “CABAB”, “DABAB”, and “EABAB”, the sub-pattern “ABAB” appears three times. The counter corresponding with “ABAB” would be incremented once for appearing in the patterns array. For each of the patterns, the log identifier can generate child patterns (which include “ABAB”) and then increment a counter corresponding to the child patterns. Since “ABAB” would be generated three times as a child pattern in addition to appearing once in the patterns array, the counter corresponding to “ABAB” would be incremented four times. The pattern identifier can then be set to convert each pattern with a corresponding counter greater than a threshold. For example, the pattern identifier can be set to preserve each pattern with a corresponding counter greater than an absolute threshold as a pattern of interest. The threshold for determining whether to preserve a child pattern in the list of unique patterns (or pattern of interest to investigate) can be static of variable. For instance, the threshold can be computed after processing the identified patterns and set based on the various aspects of the patterns overall (e.g., fraction of the total parent patterns found, length of a recurring child pattern compared to a smallest parent pattern, etc.)

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, embodiments of the disclosure may be embodied as a system, method or program code/instructions stored in one or more machine-readable media. Accordingly, embodiments may take the form of hardware, software (including firmware, resident software, micro-code, etc.), or a combination of software and hardware embodiments that may all generally be referred to herein as a “circuit,” “module” or “system.” The functionality presented as individual modules in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for embodiments of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

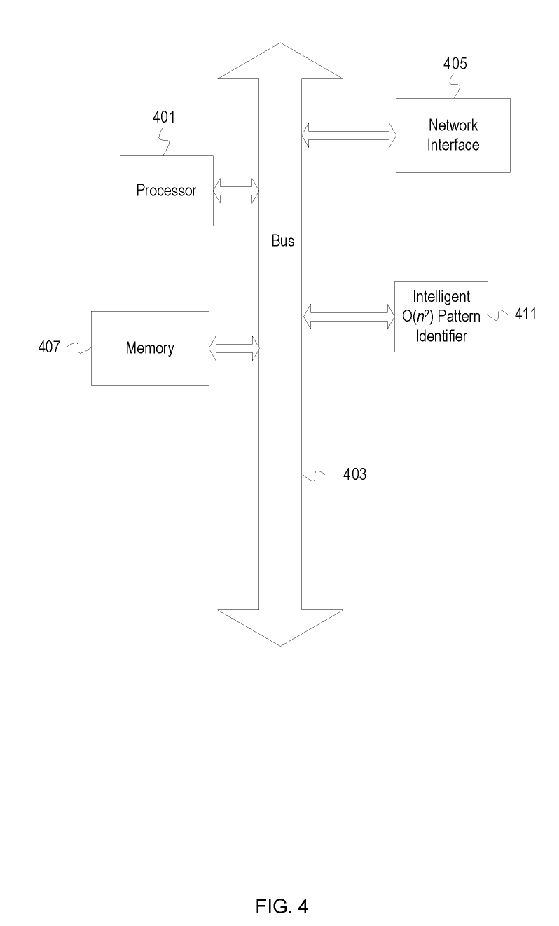

FIG. 4 depicts an example computer system with an intelligent O(n²) pattern identifier. The computer system includes a processor 401 (possibly including multiple processors, multiple cores, multiple nodes, and/or implementing multi-threading, etc.). The computer system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, HyperTransport® bus, InfiniBand® bus, NuBus, etc.) and a network interface 405 (e.g., a Fiber Channel interface, an Ethernet interface, an internet small computer system interface, SONET interface, wireless interface, etc.). The system also includes an intelligent pattern identifier 411. The pattern identifier 411 collects a log of event records and mines the log file for unique patterns in O(n²) time. The pattern identifier normalizes event records to intelligently process the log to account of variations in semantic, vocabulary, and formatting. The pattern identifier then generates a compact representation of the normalized event records by generating hash values of the event records, and then truncating the event record hashes. The degree of truncation is chosen based on collision avoidance in a space of n event records. The pattern identifier then inputs the aggregation or concatenation of truncated event record hash values as an input string into the text processing algorithms as described above to determine patterns. The pattern identifier then converts the patterns back to either indications of the event records (e.g., line numbers) or the normalized event records themselves to indicate the patterns of event records discovered by the pattern identifier. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

While the embodiments of the disclosure are described with reference to various implementations and exploitations, it will be understood that these embodiments are illustrative and that the scope of the claims is not limited to them. In general, techniques for pattern identification as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
tokenizing N first event records of a first log;
generating hashes for each of the tokenized event records;
truncating each event record hash to a length that is based, at least in part, on probability of a collision among the N truncated hash values;
maintaining a mapping of the truncated event record hashes to the first event records;
generating a sorted suffix array and a longest common prefix array with the truncated event record hashes as an input string;
identifying patterns within the input string based on the longest common prefix array;
identifying those of the patterns that are not sub-patterns among the patterns as a set of unique patterns;
for each of the set of unique patterns, determining a set of the first event records corresponding to the truncated event record hashes in the unique pattern with the mapping; and
indicating the determined sets of first event records as patterns of event records.

2. The method of claim 1, further comprising normalizing second event records to generate the first event records.

3. The method of claim 1, wherein the truncation length is also based on impact to runtime complexity for generating the sorted suffix array and the longest common prefix array.

4. The method of claim 1, wherein tokenizing comprises replacing variables occurring in the second event records with a token that represents variables.

5. The method of claim 1, wherein the length, represented as D, is computed according to the equation
D=(└log₁₀N┘+1)*∈, wherein is ∈ a value greater than or equal to 1.

6. The method of claim 1 further comprising aggregating the truncated event record hashes according to order of occurrence within the log to form the input string.

7. The method of claim 1, wherein identifying patterns within the input string based on the longest common prefix array comprises identifying common prefixes that do not occur in overlapping segments of the suffixes as patterns.

8. The method of claim 7 further comprising:
based on determining that a common prefix occurs in overlapping segments of the corresponding suffixes, identifying one of the segments as the pattern.

9. One or more non-transitory machine-readable media comprising program code for identifying patterns of event records, the program code to:
tokenize N event records in a log;
generate event record hashes from each of the tokenized event records;
truncate each of the event record hashes to a length that is based, at least in part, on a probability of a collision among the N truncated event record hashes;
maintain a mapping between the truncated event record hashes and the event records;
generate a sorted suffix array and longest common prefix array for an input string, wherein the input string comprises the truncated event record hashes;
identify patterns within the input string based on the longest common prefix array;
for each of the patterns of truncated event record hashes, determine a set of the event records represented by the truncated event records of the pattern based on the mapping; and
indicate the sets of the event records determined from the patterns as patterns of event records.

10. The non-transitory machine-readable media of claim 9, wherein the program code to identify the patterns within the input string comprises program code to identifying unique patterns of the patterns as patterns not occurring within another pattern of the input string.

11. The non-transitory machine-readable media of claim 9, wherein the program code to identify the patterns further comprises program code to identify each of the patterns based on satisfying a threshold length.

12. The non-transitory machine-readable media of claim 9, wherein the program code to identify the patterns comprises program code to determine whether a pattern occurs in overlapping segments of suffixes and select one of the segments as the pattern.

13. An apparatus comprising:
a processor; and
a machine-readable medium having program code for pattern mining event logs, the program code executable by the processor to cause the apparatus to, tokenize N first event records of a first log;
generate hashes for each of the tokenized event records;
truncate each event record hash to a length based, at least in part, on collision avoidance among the N truncated event record hashes;
maintain a mapping of the truncated event record hashes to the first event records;
generate a sorted suffix array and a longest common prefix array with the truncated event record hashes as an input string;
identify patterns within the input string based on the longest common prefix array;
identify those of the patterns that are not sub-patterns among the patterns as a set of unique patterns;
for each of the set of unique patterns, determine a set of the first event records corresponding to the truncated event record hashes in the unique pattern with the mapping; and
indicate the determined sets of first event records as patterns of event records.

14. The apparatus of claim 13, wherein the machine-readable medium further comprises program code executable by the processor to cause the apparatus to normalize second event records to generate the first event records.

15. The apparatus of claim 13, wherein the length is also based on impact on runtime of the program code to generate the sorted suffix array and the longest common prefix array.

16. The apparatus of claim 13, wherein the program code to tokenize comprises program code executable by the processor to cause the apparatus to replace variables occurring in the second event records with a token that represents variables.

17. The apparatus of claim 13, wherein the length, represented as D, is computed according to the equation
D=(└log₁₀ N┘+1)*∈, wherein is ∈ a value greater than or equal to 1.

18. The apparatus of claim 13, wherein the machine-readable medium further comprises program code executable by the processor to cause the apparatus to aggregate the truncated event record hashes according to order of occurrence within the log to form the input string.

19. The apparatus of claim 13, wherein the program code to identify patterns within the input string based on the longest common prefix array comprises program code executable by the processor to cause the apparatus to identify common prefixes that do not occur in overlapping segments of the suffixes as patterns.

20. The apparatus of claim 19, wherein the machine-readable medium further comprises program code executable by the processor to cause the apparatus to:
based on a determination that a common prefix occurs in overlapping segments of the corresponding suffixes, identify one of the segments as the pattern.
